(19) United States
(12) Patent Application Publication
(10) Pub. No.: US 2017/0178439 A1
(43) Pub. Date: Jun. 22, 2017

(54) COMPUTER IMPLEMENTED FRAMEWORKS AND METHODOLOGIES CONFIGURED TO PROVIDE ENHANCED SECURITY AND INTEGRITY IN ELECTRONIC VOTING ENVIRONMENTS

(71) Applicant: JustIssues Pty Ltd, Newport (AU)

(72) Inventor: Ralph MCKAY, Newport (AU)

(21) Appl. No.: 15/384,099

(22) Filed: Dec. 19, 2016

(30) Foreign Application Priority Data
Dec. 17, 2015 (AU) 2015271904
Dec. 17, 2015 (AU) 2015905232

(51) Int. Cl. G07C 13/00

(52) U.S. Cl. CPC G07C 13/00; G06Q 2220/10

(57) ABSTRACT

The present disclosure relates to computer implemented frameworks and methodologies configured to provide enhanced security and integrity in electronic voting environments. The inventor has identified a security flaw in certain known voting systems whereby a malicious attacker could arrange for multiple voters who make the same vote selection to be sent the same vote receipt code (with the malicious attacker submitting a fraudulent vote on behalf of an affected user). This flaw is overcome via a technical solution which involves the incorporation of additional user-defined data into a vote receipt.

### CROSS-REFERENCE TO RELATED APPLICATIONS

This application claims priority to Australian Patent Application No. 2015271904, entitled “Computer Implemented Frameworks and Methodologies Configured to Provide Enhanced Security and Integrity in Electronic Voting Environments,” filed Dec. 17, 2015, and claims priority to Australian Patent Application No. 2015905232, filed Dec. 17, 2015. The entire contents of each of which are incorporated by reference in their entirety for all purposes.

### FIELD OF THE DISCLOSURE

The present disclosure relates to computer implemented frameworks and methodologies configured to provide enhanced security and integrity in electronic voting environments. While some embodiments will be described herein with particular reference to that application, it will be appreciated that the present disclosure is not limited to such a field of use, and is applicable in broader contexts.

### BACKGROUND

Any discussion of the background art throughout the specification should in no way be considered as an admission that such art is widely known or forms part of common general knowledge in the field.

Various known electronic voting environments enable users to submit votes (for example in the context of an election) via client computing terminals. For example, in some cases users submit votes via an online environment via the Internet, using their own respective computing devices (which may include the likes of PCs, laptops, tablets and smartphones).

Security and integrity are key concerns in electronic voting environments. In particular, it is important to: (i) prevent malicious misuse of the environment, for example to submit illegitimate votes; and (ii) be able to publically demonstrate the integrity of votes that have been cast.

A known approach for enhancing security and integrity is to issue unique receipt codes to users who submit votes. This enables publication of vote receipt data comprising: the unique vote receipt codes; and the respective vote selections. It will be appreciated that personalising information of voters is not published in conjunction with vote selections (and, in some high security, data representing association between individuals and vote selections is not even recorded).

The present inventor has identified a flaw in the above approach. Specifically, a malicious attacker could arrange for multiple voters who make the same vote selection to be sent the same vote receipt code. Then, illegitimate votes are cast on behalf of all but one of those multiple voters. The affected voters will still identify their “unique” codes, but would not be aware that the codes are not unique. Furthermore, discovering that two or more voters were maliciously provided the same receipt code would be extremely difficult to identify, especially given that voters should not share their unique vote receipt codes with others (as that would enable others to identify personal vote selections).

### SUMMARY OF THE DISCLOSURE

It is an object of the present disclosure to overcome or ameliorate at least one of the disadvantages of the prior art, or to provide a useful alternative.

One embodiment provides a computer implemented method, performed by one or more server devices, configured to enable association of vote data with unique vote receipt data, the method including:

causing a client terminal to deliver a voting interface, the voting interface being configured to enable a user to: (i) uniquely identify themselves; and (ii) submit vote selection data;

causing the client terminal to deliver a personal code input object, wherein the user is enabled to input a personal code via the personal code input object, and cause that personal code to be securely transmitted to one of the one or more servers via a communications network; and

generating vote receipt data, the vote receipt data including data derived from the personal code.

One embodiment provides a method wherein generating vote receipt data includes: generating vote receipt data derived from (i) the personal code; and (ii) a unique receipt code generated by a receipt code generator.

One embodiment provides a method including storing the vote receipt data in encrypted form.

One embodiment provides a method including causing the client terminal to display a rendering of the vote receipt data.

One embodiment provides a method including causing transmission of an electronic message that is configured to enable rendering of the vote receipt data by a client terminal from which the electronic message is accessed.

One embodiment provides a method including causing publishing of vote count data, wherein the vote count data includes, for each of a plurality of users that submitted respective vote selections: the respective users': (i) vote selection data; (ii) personal code; and (iii) unique receipt code. One embodiment provides a method

One embodiment provides a method wherein generating vote receipt data includes: generating vote receipt data derived from (i) the personal code; (ii) a unique receipt code generated by a receipt code generator; and (iii) the vote selection data.

One embodiment provides a method including storing the vote receipt data in encrypted form.

One embodiment provides a method including causing the client terminal to display a rendering of the vote receipt data.

One embodiment provides a method including causing transmission of an electronic message that is configured to enable rendering of the vote receipt data by a client terminal from which the electronic message is accessed.

One embodiment provides a method including causing publishing of vote count data, wherein the vote count data includes, for each of a plurality of users that submitted respective vote selections: the respective users': (i) vote selection data; (ii) personal code; and (iii) unique receipt code.

One embodiment provides a method wherein the receipt code generator is executed at the client terminal.

One embodiment provides a method including: (i) receiving the receipt code generated by the receipt code generator at the client terminal; (ii) determining whether the receipt code is unique by comparison to previously received receipt codes; and (iii) in the case that the receipt code is not a unique comparison to previously received receipt codes, causing the receipt code generator at the client terminal to generate a further receipt code.

One embodiment provides a method wherein the personal code input object is configured to limit attributes of personal codes.

One embodiment provides a method wherein the limited attributes are defined thereby to prevent publication of predefined forms of information via publication of the personal code.

One embodiment provides a method, performed by one or more server devices, configured to enable association of vote selection data with unique vote receipt data, the method including:

causing a client terminal to deliver a voting interface, the voting interface being configured to enable a user to: (i) uniquely identify themselves; and (ii) submit vote selection data;

causing the client terminal to deliver a personal code input object, wherein the user is enabled to input a personal code via the personal code input object, and cause that personal code to be securely transmitted to one of the one or more servers via a communications network;

generating vote receipt data, the vote receipt data including data derived from the personal code, wherein generating vote receipt data includes: generating vote receipt data derived from (i) the personal code; (ii) a unique receipt code generated by a receipt code generator; and (iii) the vote selection data; and

at a predetermined time, publishing the vote count data for a plurality of users, wherein the vote count data includes, for each of a plurality of users that submitted respective vote selections, data derived from: the respective users': (i) vote selection data; (ii) personal code; and (iii) unique receipt code.

One embodiment provides a method, performed by one or more server devices, configured to enable association of vote selection data with unique vote receipt data, the method including:

causing a client terminal to deliver a voting interface, the voting interface being configured to enable a user to: (i) uniquely identify themselves; and (ii) submit vote selection data;

causing the client terminal to determine a personal code, and cause that personal code to be securely transmitted to one of the one or more servers via a communications network;

generating vote receipt data, the vote receipt data including data derived from the personal code, wherein generating vote receipt data includes: generating vote receipt data derived from (i) the personal code; (ii) a unique receipt code generated by a receipt code generator; and (iii) the vote selection data; and

at a predetermined time, publishing the vote count data for a plurality of users, wherein the vote count data includes, for each of a plurality of users that submitted respective vote selections, data derived from: the respective users': (i) vote selection data; (ii) personal code; and (iii) unique receipt code.

One embodiment provides a method wherein the personal code is defined by the user.

One embodiment provides a method wherein the personal code is defined by a code generator process executing at the client terminal.

One embodiment provides a computer program product for performing a method as described herein.

One embodiment provides a non-transitory carrier medium for carrying computer executable code that, when executed on a processor, causes the processor to perform a method as described herein.

One embodiment provides a system configured for performing a method as described herein.

Reference throughout this specification to “one embodiment”, “some embodiments” or “an embodiment” means that a particular feature, structure or characteristic described in connection with the embodiment is included in at least one embodiment of the present disclosure. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

As used herein, the term “exemplary” is used in the sense of providing examples, as opposed to indicating quality. That is, an “exemplary embodiment” is an embodiment provided as an example, as opposed to necessarily being an embodiment of exemplary quality.

### BRIEF DESCRIPTION OF THE DRAWINGS

Embodiments of the present disclosure will now be described, by way of example only, with reference to the accompanying drawings.

FIG. 1 schematically illustrates a framework according to one embodiment.

FIG. 2 illustrates a method according to one embodiment.

FIG. 3 illustrates a client-server framework leveraged by various embodiments.

FIG. 4A illustrates a prior art arrangement.

FIG. 4B illustrates a security flaw in the prior art arrangement.

FIG. 4C illustrates a technical solution that overcomes the security flaw.

### DETAILED DESCRIPTION

The present disclosure relates to computer implemented frameworks and methodologies configured to provide enhanced security and integrity in electronic voting environments. While some embodiments will be described herein with particular reference to that application, it will be appreciated that the present disclosure is not limited to such a field of use, and is applicable in broader contexts.

One embodiment provides a computer implemented method, performed by one or more server devices, configured to enable association of vote selection data with unique vote receipt data. The method includes causing a client terminal to deliver a voting interface, the voting interface being configured to enable a user to: (i) uniquely identify themselves; and (ii) submit vote selection data. The method additionally includes causing the client terminal to deliver a personal code input object, wherein the user is enabled to input a personal code via the personal code input object, and cause that personal code to be securely transmitted to one of the one or more servers via a communications network. Vote receipt data is generated, the vote receipt data including data derived from (i) the personal code; (ii) a unique receipt code generated by a receipt code generator; and (iii) the vote selection data. At a predetermined time, vote count data is published for a plurality of users. The vote count data includes, for each of a plurality of users that submitted respective vote selections, data derived from the respective users': (i) vote selection data; (ii) personal code; and (iii) unique receipt code. It will be appreciated from the discussion below that such an approach provides a technical solution to overcoming potential malicious breaches to prior art voting environments.

### Context to Technical Problem and Solution

Various known electronic voting environments enable users to submit votes (for example in the context of an election) via client computing terminals. For example, in some cases users submit votes via an online environment via the Internet, using their own respective computing devices (which may include the likes of PCs, laptops, tablets and smartphones).

Security and integrity are key concerns in electronic voting environments. In particular, it is important to: (i) prevent malicious misuse of the environment, for example to submit illegitimate votes; and (ii) be able to publically demonstrate the integrity of votes that have been cast.

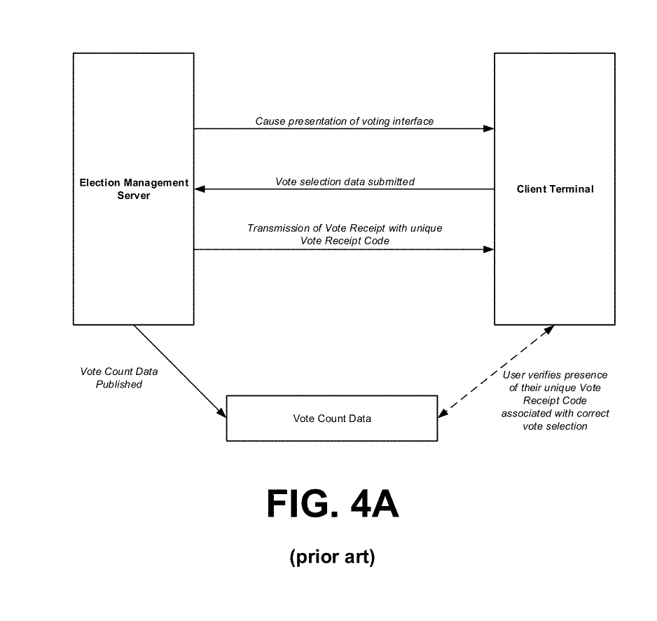

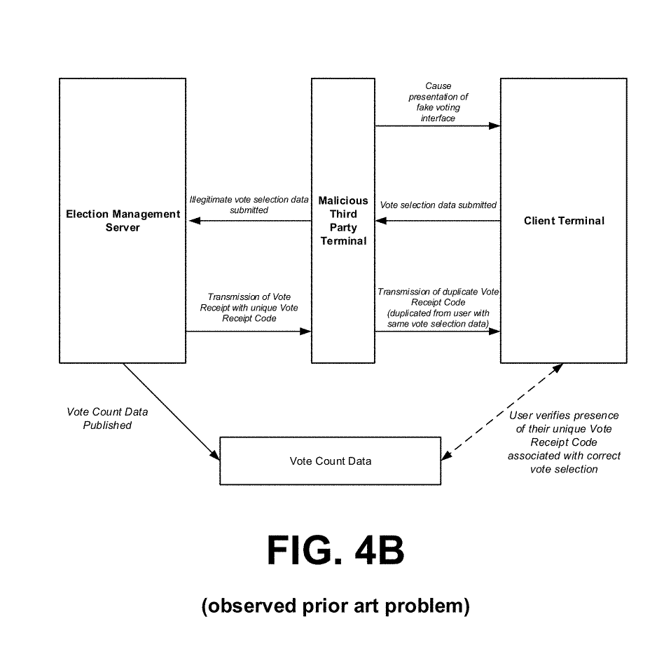

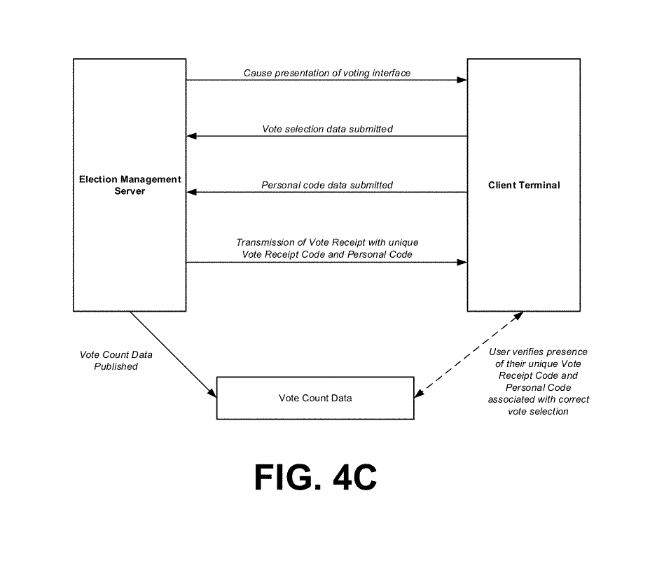

A known approach for enhancing security and integrity is to issue unique receipt codes to users who submit votes, for example as shown in FIG. 4A. The server causes presentation of a voting interface at a client terminal, a user of the client terminal submit vote selection data (the term “vote selection data” is used herein to generically describe data representative of a user's selections in response to a voting prompt). The server receives the vote selection data (VSD), and generates a unique vote receipt code (VRC). The server stores the VSD in conjunction with the VRC, and transmits to the user a receipt containing the VSD and VRC. The server also publishes vote count data which contains, for all voting users, the VRCs and associated VSD. This allows each user to check the count data, identify their unique VRC, and verify that the correct VSD has been recorded.

Typically, personalising information of voters is not published in the vote count data, as users' vote selections are to remain anonymous. Indeed, in some high security applications, data representing association between individuals and vote selections is not even recorded.

The present inventor has identified a security/integrity concern in the above approach. As shown in FIG. 4B, a malicious attacker could arrange for multiple voters who make the same vote selection to be sent the same vote receipt code. There are a range of ways in which such a malicious attack might be achieved, for example by way of using a phishing type attack, such as by providing a fake voting interface as shown in FIG. 4B. The attack might be conducted as follows:
A malicious attacker obtains unique VRCs (and associated VSD) for one or more users.
The malicious attacker intercepts a transmission of VSD for a given user, for example by having a user access a fake voting interface.
The malicious attacker identifies an obtained VRC having the same associated VSD, and uses that to provide a voting receipt to the user.
The malicious attacker submits an illegitimate vote on behalf of the user.
The user, in reviewing the vote count data, still sees their VRC (which they believe to be unique) with the correct VSD.
The illegitimate vote appears in the vote count data, but only the malicious attacker knows the associated unique VRC.

An alternate approach to exploiting vulnerability would be to infiltrate the server-side voting software itself, thereby to modify its operation and record illegitimate votes whilst transmitting duplicate receipt codes in a similar fashion to that described above.

In either case, fact that two or more voters were maliciously provided the same receipt code would be extremely difficult to identify, especially given that voters should not share their unique vote receipt codes with others (as that would enable others to identify personal vote selections). Optimally, the malicious attacker would maintain a constrained ratio of illegitimate votes to duplicated VRCs, thereby to reduce the likelihood of detection.

The solution described herein includes, as shown in FIG. 4C, causing the voting interface to obtain, from each voting user, a user-defined “personal code”, which may be an alphanumeric code satisfying defined attribute requirements (for example length, combination of character types, and so on). The personal codes are included in the vote count data. A malicious attacker is unable to operate in the manner shown in FIG. 4A, as a combination of the personal code, VRC and VSD can only be achieved by the election management server. Even if the malicious attacker were to intercept the personal code, it would not be possible to submit an illegitimate vote with that personal code without incorrect VSD being identifiable by the user in the vote count data.

Exemplary Framework

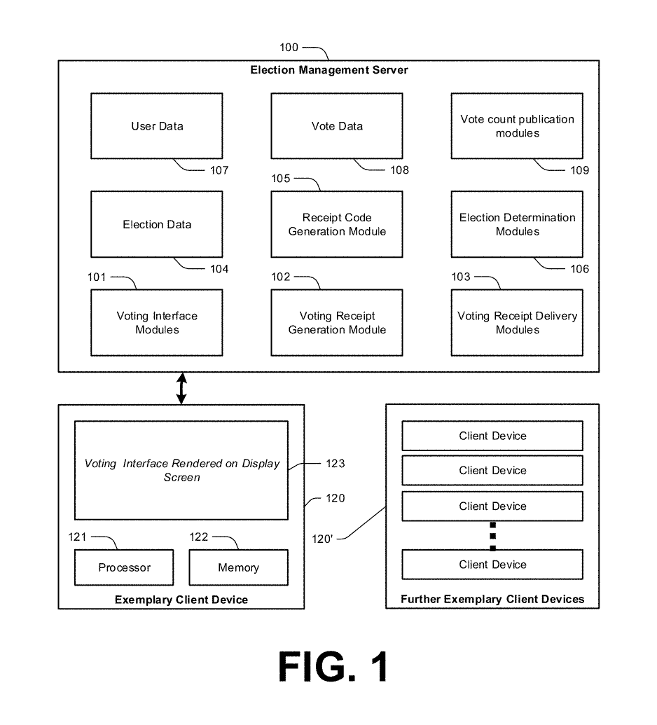

FIG. 1 illustrates a framework according to one embodiment. Components illustrated in this diagram (such as interfaces and modules) are not representative of individual distinct software programs; rather the framework is described by reference to functionally identifiable components, which in various embodiments are delivered collectively via one or more software applications.

An election management server 100 is configured to interact with a plurality of client devices, including an exemplary client device 120, which is intended to be generically representative of substantially any form of client device, or a desktop personal computer), and further client devices 120′. The client devices may include substantially any computing devices, including desktop computers, laptop computers, tablets, smartphones, gaming devices, and the like. The client devices each execute respective software applications that enable the local rendering of user interface components which facilitate interaction between a local user and server 100. For example, client devices may provide such user interface components via: (i) a web browser application, which is configured to download user interface components from one or more web servers, and render those to provide the user interface components; or (ii) a proprietary locally executing software application (such as a mobile app operating on iOS or Android) which is inherently adapted to maintain a communication channel with server 100. Client device 120 includes a processor 121 configured to execute software instructions maintained in a memory unit 122 (for example software instructions representing a web browser application or a proprietary locally executing software application), thereby to render a user interface on a display screen 123. In the example of FIG. 1, a voting interface is rendered on display screen 123.

A user of client device 120 interacts with server 100 thereby to login (or otherwise be uniquely identified) via defined credentials (this interaction may occur via one or more additional networked devices, for instance via a website/web server arrangement, proprietary app arrangement, and the like). For example, each user is associated with a username and password, optionally along with other personalising information. This is maintained in a repository of user record data 107.

Server 100 maintains access to a repository of election data, which includes data defining attributes for one or more elections that are being or are to be conducted. The term “election” is used herein to generically describe any event in which users submit votes. Based on election data 104, voting interface modules 101 cause the user interface displayed at a given client terminal to display user interface components to allow the submission of votes in one or more elections in which the user is designated for participation, during a defined voting time window. For example, this includes causing a client terminal to deliver a voting interface, the voting interface being configured to enable a user to: (i) uniquely identify themselves; and (ii) submit vote selection data. Data representative of user's votes is stored in vote data 108. This data preferably does not individually associate votes with users; rather it associates, for each vote, vote selection data (VSD) with one or more identifiers.

In this case, there are two identifiers used. These are: (i) a randomly generated unique identifier in the form of a vote receipt code (VRC); and (ii) a user-generated identifier in the form of a personal vote code (PVC).

The voting interface is configured to cause the client terminal to deliver a PVC input object via the voting interface. The user is enabled to input a PVC via the PVC input object, and cause that PVC to be securely transmitted to one of the one or more servers via a communications network to server 100.

In the illustrated embodiment, the server includes a VRC generation module 105, which is configured to generate a unique VRC for each submitted vote. In some embodiments the VRC generator is provided via software executed at the client terminal. In some such embodiments, to ensure uniqueness, server 100 performs a method including: (i) receiving the VRC generated by the VRC generator at the client terminal; (ii) determining whether the VRC is unique by comparison to previously received VRCs; and (iii) in the case that the VRC is not a unique comparison to previously received VRCs, causing the receipt code generator at the client terminal to generate a further VRC. The method is repeated until a unique VRC is generated. In a further embodiment, a client-side VRC defines the PVC.

A vote receipt generation module 102 is configured to generate vote receipt data in response to a user's vote placed via a client terminal. The vote receipt data includes data derived from the PVC. In a preferred embodiment the vote receipt data is derived from (i) the PVC; (ii) the VRC; and (iii) the VSD. For example, it is a data set that, when rendered, displays those three aspects of data.

Preferably, server 100 is configured to store the vote receipt data in vote data 108, partially or fully in encrypted form. Additionally, modules 101 are preferably configured to cause the client terminal to display a rendering of the vote receipt data immediately following successful receiving and processing of the user's vote. In some cases, voting receipt delivery modules are configured to cause transmission of an electronic message that is configured to enable rendering of the vote receipt data by a client terminal from which the electronic message is accessed (for example an email containing an attachment or hyperlink).

Election determination modules 106 are configured to determine election results at the culmination of a voting period defined in election data 104. Vote count publication modules 109 are configured to cause generation and/or publishing of vote count data showing the details of votes counted in the context of election result determination. The vote count data includes, for each of a plurality of users that submitted respective vote selections: the respective users': (i) vote selection data; (ii) personal code; and (iii) unique receipt code.

Preferably, restrictions are placed on attributes of PVC, for example requiring a particular form of combination of alphanumeric and non-alphanumeric characters. For example, this is used to reduce the ability of users to include obscenities or the like in PVC (to avoid publishing such material in the vote count).

It will be appreciated that publishing of vote count data defined in the described manner allows malicious attacks such as that shown in FIG. 4B to be more readily identified (for example by the voters themselves in a transparent audit process) by way of reviewing the vote count data.

The framework of FIG. 1 is described by reference to a fairly generic voting environment. It should be appreciated that inventive aspects of the technology, being technical solutions to voting security and/or integrity, are implemented across a wide range of voting environments, and should not be limited to any particular environment.

Exemplary Method

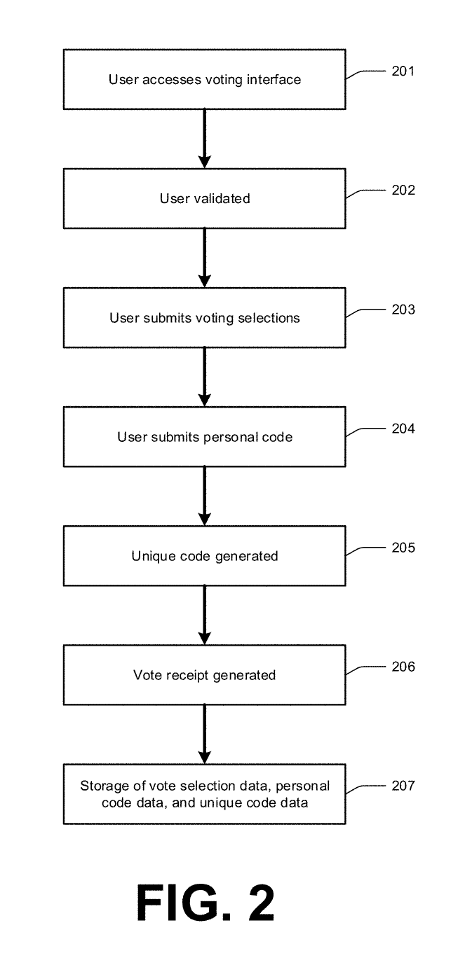

FIG. 2 illustrates a method according to one embodiment. Block 201 represents a process whereby a user accesses a voting interface. The user is validated at block 202 (for example to verify that the user is (i) eligible to vote; and (ii) has not voted previously). The user then submits voting selections (VSD) at 203, for example by clicking one or more checkboxes and clicking a “submit” object. This causes transmission of VSD via secure/encrypted communications. The user also submits a personal code (PVC) at block 204 (for example an alphanumeric code generated by the user, optionally using a client-side random code generator tool), which is again submitted via secure/encrypted communications. Block 205 represents a process whereby a unique code is generated in respect of a received vote (a VRC). Block 206 represents a process including generating vote receipt data, based on the VSD, NRC and PVC. The receipt data is stored at 207.

Further Embodiment: Password Protected Voting Receipts

In some embodiments, a PVC is used alternately or additionally as a means to define a password which controls access to vote receipt data. For example, in a preferred embodiment vote receipt data is transmitted by email to the user, with the vote receipt data being contained in an attached file that is password protected using a PVC defined by the user (for example at the time of voting).

Such an approach is useful in reducing the potential for a malicious attacker from sending duplicate vote receipts to users. In particular, there is an additional technical hurdle created by requiring that a voting receipt be password protected by a password provided by the user; a malicious attacker would need to intercept data representative of that password.

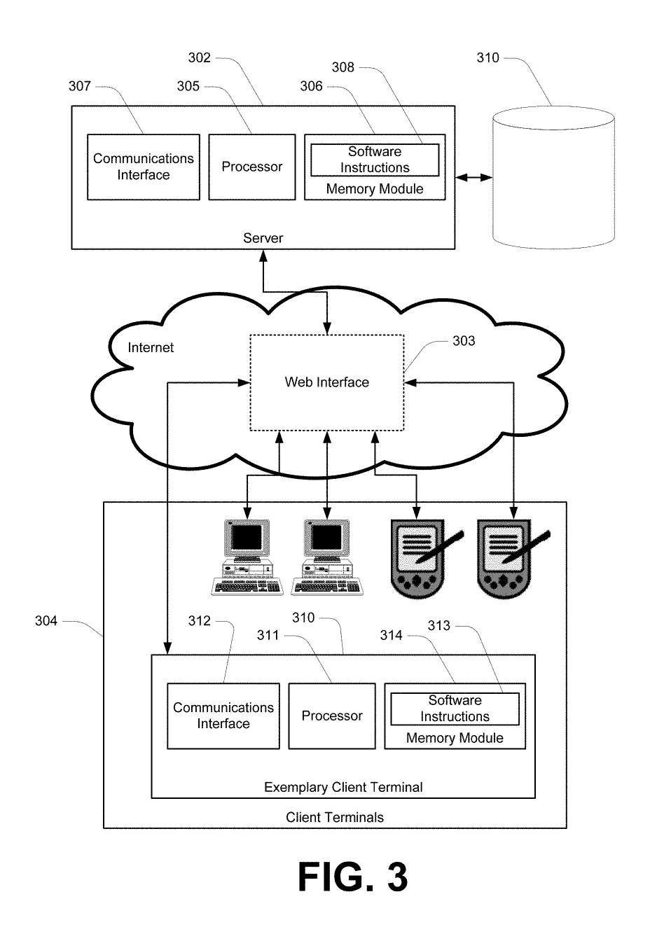

Exemplary Client-Server Framework In some embodiments, methods and functionalities considered herein are implemented by way of a client-server arrangement, as illustrated in FIG. 3. In overview, a web server 302 provides a web interface 303. This web interface is accessed by the parties by way of client terminals 304. In overview, users access interface 303 over the Internet by way of client terminals 304, which in various embodiments include the likes of personal computers, PDAs, cellular telephones, gaming consoles, and other Internet enabled devices.

Server 303 includes a processor 305 coupled to a memory module 306 and a communications interface 307, such as an Internet connection, modem, Ethernet port, wireless network card, serial port, or the like. In other embodiments distributed resources are used. For example, in one embodiment server 302 includes a plurality of distributed servers having respective storage, processing and communications resources. Memory module 306 includes software instructions 308, which are executable on processor 305.

Server 302 is coupled to a database 310. In further embodiments the database leverages memory module 306.

In some embodiments web interface 303 includes a website. The term “website” should be read broadly to cover substantially any source of information accessible over the Internet or another communications network (such as WAN, LAN or WLAN) via a browser application running on a client terminal. In some embodiments, a website is a source of information made available by a server and accessible over the Internet by a web-browser application running on a client terminal. The web-browser application downloads code, such as HTML code, from the server. This code is executable through the web-browser on the client terminal for providing a graphical and often interactive representation of the website on the client terminal. By way of the web-browser application, a user of the client terminal is able to navigate between and throughout various web pages provided by the website, and access various functionalities that are provided.

Although some embodiments make use of a website/browser-based implementation, in other embodiments proprietary software methods are implemented as an alternative. For example, in such embodiments client terminals 304 maintain software instructions for a computer program product that essentially provides access to a portal via which framework 100 is accessed (for instance via an iPhone app or the like).

In general terms, each terminal 304 includes a processor 311 coupled to a memory module 313 and a communications interface 312, such as an internet connection, modem, Ethernet port, serial port, or the like. Memory module 313 includes software instructions 314, which are executable on processor 311. These software instructions allow terminal 304 to execute a software application, such as a proprietary application or web browser application and thereby render on-screen a user interface and allow communication with server 302. This user interface allows for the creation, viewing and administration of profiles, access to the internal communications interface, and various other functionalities.

Interpretation

Unless specifically stated otherwise, as apparent from the following discussions, it is appreciated that throughout the specification discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. Each processor may include one or more of a CPU, a graphics processing unit, and a programmable DSP unit. The processing system further may include a memory subsystem including main RAM and/or a static RAM, and/or ROM. A bus subsystem may be included for communicating between the components. The processing system further may be a distributed processing system with processors coupled by a network. If the processing system requires a display, such a display may be included, e.g., a liquid crystal display (LCD) or a cathode ray tube (CRT) display. If manual data entry is required, the processing system also includes an input device such as one or more of an alphanumeric input unit such as a keyboard, a pointing control device such as a mouse, and so forth. The term memory unit as used herein, if clear from the context and unless explicitly stated otherwise, also encompasses a storage system such as a disk drive unit. The processing system in some configurations may include a sound output device, and a network interface device. The memory subsystem thus includes a computer-readable carrier medium that carries computer-readable code (e.g., software) including a set of instructions to cause performing, when executed by one or more processors, one of more of the methods described herein. Note that when the method includes several elements, e.g., several steps, no ordering of such elements is implied, unless specifically stated. The software may reside in the hard disk, or may also reside, completely or at least partially, within the RAM and/or within the processor during execution thereof by the computer system. Thus, the memory and the processor also constitute computer-readable carrier medium carrying computer-readable code.

Furthermore, a computer-readable carrier medium may form, or be included in a computer program product.

In alternative embodiments, the one or more processors operate as a standalone device or may be connected, e.g., networked to other processor(s), in a networked deployment, the one or more processors may operate in the capacity of a server or a user machine in server-user network environment, or as a peer machine in a peer-to-peer or distributed network environment. The one or more processors may form a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine.

Note that while diagrams only show a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

Thus, one embodiment of each of the methods described herein is in the form of a computer-readable carrier medium carrying a set of instructions, e.g., a computer program that is for execution on one or more processors, e.g., one or more processors that are part of web server arrangement. Thus, as will be appreciated by those skilled in the art, embodiments of the present disclosure may be embodied as a method, an apparatus such as a special purpose apparatus, an apparatus such as a data processing system, or a computer-readable carrier medium, e.g., a computer program product. The computer-readable carrier medium carries computer readable code including a set of instructions that when executed on one or more processors cause the processor or processors to implement a method. Accordingly, aspects of the present disclosure may take the form of a method, an entirely hardware embodiment, an entirely software embodiment or an embodiment combining software and hardware aspects. Furthermore, the present disclosure may take the form of carrier medium (e.g., a computer program product on a computer-readable storage medium) carrying computer-readable program code embodied in the medium.

The software may further be transmitted or received over a network via a network interface device. While the carrier medium is shown in an exemplary embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present disclosure. A carrier medium may take many forms, including but not limited to, non-volatile media, volatile media, and transmission media. Non-volatile media includes, for example, optical, magnetic disks, and magneto-optical disks. Volatile media includes dynamic memory, such as main memory. Transmission media includes coaxial cables, copper wire and fiber optics, including the wires that comprise a bus subsystem. Transmission media also may also take the form of acoustic or light waves, such as those generated during radio wave and infrared data communications. For example, the term “carrier medium” shall accordingly be taken to included, but not be limited to, solid-state memories, a computer product embodied in optical and magnetic media; a medium bearing a propagated signal detectable by at least one processor of one or more processors and representing a set of instructions that, when executed, implement a method; and a transmission medium in a network bearing a propagated signal detectable by at least one processor of the one or more processors and representing the set of instructions.

It will be understood that the steps of methods discussed are performed in one embodiment by an appropriate processor (or processors) of a processing (i.e., computer) system executing instructions (computer-readable code) stored in storage. It will also be understood that the present disclosure is not limited to any particular implementation or programming technique and that the present disclosure may be implemented using any appropriate techniques for implementing the functionality described herein. The present disclosure is not limited to any particular programming language or operating system.

It should be appreciated that in the above description of exemplary embodiments of the present disclosure, various features of the present disclosure are sometimes grouped together in a single embodiment, FIG., or description thereof for the purpose of streamlining the disclosure and aiding in the understanding of one or more of the various inventive aspects. This method of disclosure, however, is not to be interpreted as reflecting an intention that the claimed present disclosure requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this present disclosure.

Furthermore, while some embodiments described herein include some but not other features included in other embodiments, combinations of features of different embodiments are meant to be within the scope of the present disclosure, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the present disclosure.

In the description provided herein, numerous specific details are set forth. However, it is understood that embodiments of the present disclosure may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the present disclosure, those skilled in the art will recognize that other and further modifications may be made thereto without departing from the spirit of the present disclosure, and it is intended to claim all such changes and modifications as falling within the scope of the present disclosure. For example, any formulas given above are merely representative of procedures that may be used. Functionality may be added or deleted from the block diagrams and operations may be interchanged among functional blocks. Steps may be added or deleted to methods described within the scope of the present disclosure.

1. A computer implemented method, performed by one or more server devices, configured to enable association of vote data with unique vote receipt data, the method including:
causing a client terminal to deliver a voting interface, the voting interface being configured to enable a user to: (i) uniquely identify themselves; and (ii) submit vote selection data;
causing the client terminal to deliver a personal code input object, wherein the user is enabled to input a personal code via the personal code input object, and cause that personal code to be securely transmitted to one of the one or more servers via a communications network; and
generating vote receipt data, the vote receipt data including data derived from the personal code.

2. The method according to claim 1, wherein generating vote receipt data includes: generating vote receipt data derived from (i) the personal code; and (ii) a unique receipt code generated by a receipt code generator.

3. The method according to claim 2, including storing the vote receipt data in encrypted form.

4. The method according to claim 2, including causing the client terminal to display a rendering of the vote receipt data.

5. The method according to claim 2, including causing transmission of an electronic message that is configured to enable rendering of the vote receipt data by a client terminal from which the electronic message is accessed.

6. The method according to claim 2, including causing publishing of vote count data, wherein the vote count data includes, for each of a plurality of users that submitted respective vote selections: the respective users': (i) vote selection data; (ii) personal code; and (iii) unique receipt code.

7. The method according to claim 1, wherein generating vote receipt data includes: generating vote receipt data derived from (i) the personal code; (ii) a unique receipt code generated by a receipt code generator; and (iii) the vote selection data.

8. The method according to claim 7, including storing the vote receipt data in encrypted form.

9. The method according to claim 7, including causing the client terminal to display a rendering of the vote receipt data.

10. The method according to claim 7, including causing transmission of an electronic message that is configured to enable rendering of the vote receipt data by a client terminal from which the electronic message is accessed.

11. The method according to claim 2, including causing publishing of vote count data, wherein the vote count data includes, for each of a plurality of users that submitted respective vote selections: the respective users': (i) vote selection data; (ii) personal code; and (iii) unique receipt code.

12. The method according to claim 1, wherein the receipt code generator is executed at the client terminal.

13. The method according to claim 12, including: (i) receiving the receipt code generated by the receipt code generator at the client terminal; (ii) determining whether the receipt code is unique by comparison to previously received receipt codes; and (iii) in the case that the receipt code is not a unique comparison to previously received receipt codes, causing the receipt code generator at the client terminal to generate a further receipt code.

14. The method according to claim 1, wherein the personal code input object is configured to limit attributes of personal codes.

15. The method according to claim 14, wherein the limited attributes are defined thereby to prevent publication of predefined forms of information via publication of the personal code.

16. A computer implemented method, performed by one or more server devices, configured to enable association of vote selection data with unique vote receipt data, the method including:
causing a client terminal to deliver a voting interface, the voting interface being configured to enable a user to: (i) uniquely identify themselves; and (ii) submit vote selection data;
causing the client terminal to deliver a personal code input object, wherein the user is enabled to input a personal code via the personal code input object, and cause that personal code to be securely transmitted to one of the one or more servers via a communications network; generating vote receipt data, the vote receipt data including data derived from the personal code, wherein generating vote receipt data includes: generating vote receipt data derived from (i) the personal code; (ii) a unique receipt code generated by a receipt code generator; and (iii) the vote selection data; and
at a predetermined time, publishing the vote count data for a plurality of users, wherein the vote count data includes, for each of a plurality of users that submitted respective vote selections, data derived from: the respective users': (i) vote selection data; (ii) personal code; and (iii) unique receipt code.

17. A computer implemented method, performed by one or more server devices, configured to enable association of vote selection data with unique vote receipt data, the method including:
causing a client terminal to deliver a voting interface, the voting interface being configured to enable a user to: (i) uniquely identify themselves; and (ii) submit vote selection data;
causing the client terminal to determine a personal code, and cause that personal code to be securely transmitted to one of the one or more servers via a communications network;
generating vote receipt data, the vote receipt data including data derived from the personal code, wherein generating vote receipt data includes: generating vote receipt data derived from (i) the personal code; (ii) a unique receipt code generated by a receipt code generator; and (iii) the vote selection data; and
at a predetermined time, publishing the vote count data for a plurality of users, wherein the vote count data includes, for each of a plurality of users that submitted respective vote selections, data derived from: the respective users': (i) vote selection data; (ii) personal code; and (iii) unique receipt code.

18. The method according to claim 17, wherein the personal code is defined by the user.

19. The method according to claim 17, wherein the personal code is defined by a code generator process executing at the client terminal.
